(19) United States
(12) Patent Application Publication
(10) Pub. No.: US 2026/0133872 A1
(43) Pub. Date: May 14, 2026

(54) SYSTEMS AND METHODS FOR AUTOMATED MAINTENANCE OF COMPUTING DEVICES

(71) Applicant: MacPaw Way Ltd., Limassol (CY)

(72) Inventors: Oleksandr TATARCHUK, Valencia (ES); Roman TIKHONYCHEV, Kyiv (UA); Yevhenii PAVLOVSKYI, Dnipro Region (UA); Danylo KHATSANOVSKYI, Valencia (ES); Roman ZOLOTUKHA, Kyiv (UA); Oleksandr VOLOSHCHENKO, Makariv (UA); Yurii TROKHYMCHUK, Kyiv (UA); Oleksii KASIANOV, Kyiv (UA)

(21) Appl. No.: 19/387,474

(22) Filed: Nov. 12, 2025

Related U.S. Application Data
(60) Provisional application No. 63/719,756, filed on Nov. 13, 2024.

(51) Int. Cl. G06F 11/07

(52) U.S. Cl. CPC G06F 11/0793; G06F 11/0709

(57) ABSTRACT

Systems and methods described herein monitor and maintain the health of computing devices within a network by receiving system health data from a data collector application on each device. The health data encompasses hardware performance, software version, security status, network configuration, and error logs. A health index is calculated by using a formula, where each health factor represents an aspect of device health. A visual representation of the health index is generated, highlighting components that negatively impact health. This visual data, along with suggested remedial actions, is provided to a dashboard interface to ensure compliance with organizational policies. Automated responses, including configuration adjustments or software updates, are triggered when specified health conditions are met.

### CROSS REFERENCES TO RELATED APPLICATIONS

This application claims priority benefit to U.S. Provisional Patent Application No. 63/719,756 entitled “Systems and Methods for Automated Maintenance of Computing Devices,” filed on Nov. 13, 2024, which is expressly incorporated by reference herein in its entirety and for all purposes.

### BACKGROUND

### Field

The present disclosure is generally directed to computing device health management, and more specifically, to systems and methods for monitoring, assessing, and automating the maintenance of computing devices.

### Related Art

In modern organizations, managing the health and performance of computing devices is a critical responsibility for IT administrators. As organizations increasingly rely on a diverse range of devices, including laptops, desktops, and mobile devices, the need for centralized, efficient monitoring, maintenance, and compliance has become more pressing. Traditionally, administrators are tasked with gathering information about each device's hardware performance, software versions, security configurations, and network settings through a variety of disconnected tools and manual processes.

Existing device management solutions typically focus on providing fragmented isolated data points, such as CPU usage, memory utilization, software update status, or security compliance, but fail to offer a comprehensive, holistic view of a device's overall health. This scattered approach leaves administrators burdened with the challenge of manually correlating disparate data sources to identify critical issues. Furthermore, these solutions often rely on linear, additive methods of assessing device health, which may overlook critical problems if certain metrics appear within acceptable ranges, even when one or more issues are severe.

Another significant limitation of existing approaches is their reactive nature. They only notify administrators after a problem has already been escalated, resulting in costly downtime, security vulnerabilities, or performance degradation. Without comprehensive, real-time overview of the device fleet's health, administrators struggle to perform preventive maintenance, leading to inefficient resource allocation and delayed decision-making.

In addition, existing approaches often require technical expertise to interpret the data, limiting accessibility to non-expert users and slowing down the decision-making process. In large organizations with hundreds or thousands of devices, the complexity of managing and ensuring compliance across the fleet becomes overwhelming, especially when manual interventions are required for maintenance tasks, software updates, or policy enforcement.

It would be desirable to have systems and methods that offer a unified, real-time health index reflecting the overall state of each device, provide proactive maintenance capabilities, and automate routine tasks to reduce the administrative burden. Accordingly, systems and methods described herein facilitate decision-making by making complex technical data more accessible and actionable for administrators at all levels of expertise.

### SUMMARY

In some aspects of the disclosure, a method for monitoring and maintaining the health of computing devices in a network compromises: at a backend system, receiving system health data from a data collector application associated with a computing device, the system health data including at least one of a hardware performance metric, a software version, a security status, a network configuration, or an error log; using sensors to measure physical parameters comprising at least one of temperature, voltage, or current associated with the computing device; incorporating the measured physical parameters into the system health data; analyzing the system health data to calculate a health index associated with the computing device by using a formula comprising health factors that each represents a health aspect of at least one system component associated with the computing device; generating a visual representation including at least one of the health index and one or more system components that negatively impact the health index; providing to a dashboard interface the visual representation and one or more suggestions for remedial actions for the one or more system components to ensure compliance with an organizational policy; and based on one or more health factors meeting a condition, triggering an automated response including at least one of a configuration adjustment or a software update to ensure compliance with the organizational policy.

In some aspects, the data collector application monitors and collects software version information, which includes at least one of an installed application or its current version, hardware performance metric including at least one of a CPU usage, a memory utilization, a disk space, or a security compliance status. The data collector application may further report the system health data based on information gathered within a time interval, and wherein the backend system aggregates the system health data from all computing devices in a network to present a holistic view of device health at an organizational level and recalculates the health index in response to a real-time change in a system status of the computing device.

In some aspects, the backend system aggregates the system health data to provide organizational information including a device health summary based on at least one of a department, a location, or a device grouping, and provides a comparative analysis of device health across the network.

In some aspects, a zero value in a health factor causes the health index to assume a zero value, the health index being displayed as a percentage value ranging from 0 to 100, where 100 indicates an optimal health and 0 indicates a failure.

In some aspects, the dashboard interface visually represents the health index using color-coded indicators, provides filters to view device health based on a criterion, and shows a contribution of each of the one or more health factors to the health index. The dashboard interface may display a contribution of the one or more system components and provides a real-time monitoring result of system health to trigger a response when a critical issue has been detected.

In some aspects, the automated response includes at least one of initiating a software update or generating an alert or a notification for an administrator when the health index of the computing device falls below a predefined threshold.

In some aspects, the backend system displays a metric that includes at least one of an average health index, a number of devices associated with a critical issue, or a device requiring immediate attention.

In some aspects, the backend system enables long-term trend analysis and performance monitoring by storing historical system health data for each computing device and tracking trends in the system health data over time to identify patterns, predict potential failures, and recommend preventive actions based on historical performance.

In some aspects, the backend system allows customization of alerts and notifications based on specific thresholds for one or more health factors, and provides access control to enable different levels of access to health data and automated responses based on user status.

In some aspects, the backend system automatically schedules preventive maintenance tasks including a software update, a diagnostic test, and a security compliance check based on predefined health thresholds, and automatically enforces preventive measures including at least one of a security policy compliance, disk space management, or software update scheduling based on one or more predetermined conditions.

In some aspects, the backend system dynamically recalculates the health index in response to a real-time update in system health data, which includes a change in security compliance, the hardware performance metric, or a software status, and prioritizes health factors that include the security compliance or the hardware performance metric.

In some aspects, the backend system automatically, in response to detecting a deviation, enforces compliance with an organizational security or software policy to initiate a corrective action.

In some aspects, the techniques described herein relate to a non-transitory computer readable medium for storing instructions for executing a process, the instructions including: receiving system health data at a backend system from a data collector application associated with a computing device, the system health data including at least one of a hardware performance, a software version, a security status, a network configuration, or an error log; using sensors to measure physical parameters comprising at least one of temperature, voltage, or current associated with the computing device; incorporating the measured physical parameters into the system health data; analyzing the system health data to calculate a health index associated with the computing device by using a formula comprising health factors that each represents a health aspect of at least one system component associated with the computing device; generating a visual representation including at least one of the health index and one or more system components that negatively impact the health index; providing to a dashboard interface the visual representation and one or more suggestions for remedial actions for the one or more system components to ensure compliance with an organizational policy; and based on one or more health factors meeting a condition, triggering an automated response including at least one of a configuration adjustment or a software update to ensure compliance with the organizational policy.

Aspects of the present disclosure can involve a system, which can involve means for performing steps comprising: receiving system health data from a data collector application associated with a computing device, the system health data including at least one of a hardware performance metric, a software version, a security status, a network configuration, or an error log; means for using sensors to measure physical parameters comprising at least one of temperature, voltage, or current associated with the computing device; means for incorporating the measured physical parameters into the system health data; means for analyzing the system health data to calculate a health index associated with the computing device by using a formula comprising health factors that each represents a health aspect of at least one system component associated with the computing device; means for generating a visual representation including at least one of the health index and one or more system components that negatively impact the health index; means for providing to a dashboard interface the visual representation and one or more suggestions for remedial actions for the one or more system components to ensure compliance with an organizational policy; and means for triggering, based on one or more health factors meeting a condition, an automated response including at least one of a configuration adjustment or a software update to ensure compliance with the organizational policy.

### BRIEF DESCRIPTION OF DRAWINGS

FIG. 1 illustrates a system for monitoring and maintaining the health of computing devices in a network according to various embodiments of the present disclosure.

FIG. 2 is a flowchart illustrating an exemplary process for monitoring and maintaining the health of computing devices in a network according to various embodiments of the present disclosure.

FIG. 3 illustrates an example computing environment according to various embodiments of the present disclosure.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

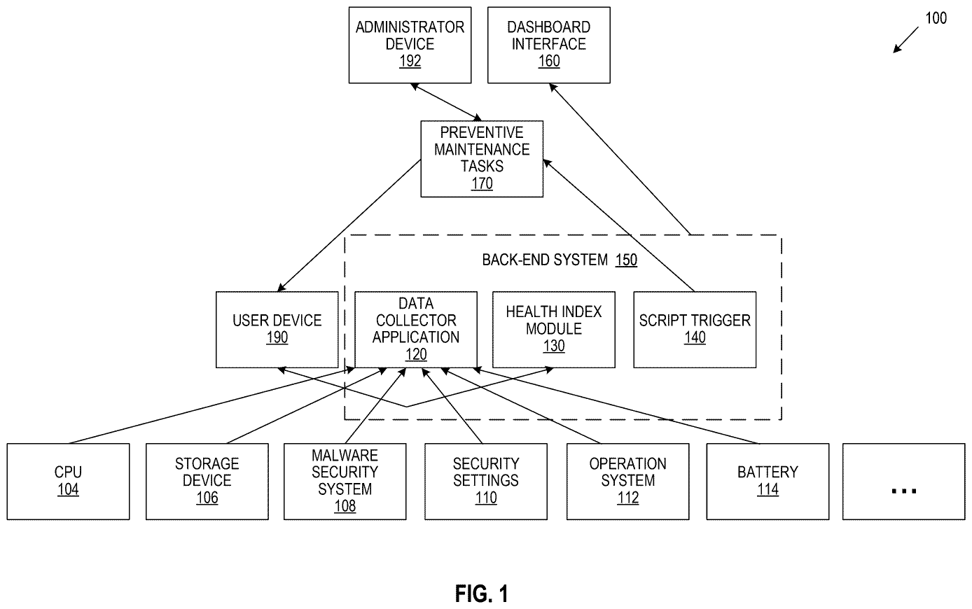

FIG. 1 illustrates a system for monitoring and maintaining the health of computing devices in a network according to various embodiments of the present disclosure. In embodiments system 100 comprises computing device 102, which comprises components such as CPU 104, storage 104, storage device 106, malware security system 108, security settings 110, operating system 112, and battery 114. As depicted in FIG. 1, system 100 further comprises backend system 150, which includes components such as data collector application 120, script trigger 140, and real-time health index module 130. It is understood that system 100 may comprise different or additional components, such as user activity logs, hardware sensors, and software applications, network configuration, which are not expressly shown in FIG. 1.

In operation, system 100 collects data from any number of components associated with computing device 102 to generate a unified health index representing the overall health of the device within system 100. Data collector application 120, which is deployed on computing device 102, gathers real-time metrics from various components, including CPU 104, battery 114, and security settings 110. Exemplary metrics that may be gathered comprise hardware performance, software update status, security compliance status, network configuration, and error logs. The collected data may include information about the presence of malware, as determined by malware security system 108; compliance data retrieved from security settings 110; battery health and usage information from battery 114; operating system updates on software versions and patches from operating system 112; and storage performance metrics, such as disk usage, obtained from storage device 106. This comprehensive data collection enables system 100 to monitor device health continuously and accurately.

Data collector application 120 reports the gathered data to backend system 150 at regular intervals (e.g., every 72 hours) to ensure that the health index remains reflective of the recent state of each computing device (e.g., 102).

In embodiments, the data collected by data collector application 120 is transmitted to backend system 150, where it is processed by health index module 130. As discussed in greater detail bellow, health index module 130 may normalize the incoming data and apply a multiplicative health index formula to compute a health score, e.g., with the values ranging from 0 to 100. A score of 100 indicates optimal health, whereas a score of 0 may indicate a critical failure. This multiplicative approach prioritizes critical issues by substantially lowering the overall health score when significant anomalies are detected. Such embodiments ensure that any critical issue (e.g., malware presence or security misconfiguration) immediately lowers the health score, drawing administrator attention to devices requiring urgent intervention. It is noted that although the health index formula is generally described in the context of a multiplicative formula, it is understood that this is not intended to limit the scope of the present disclosure to such embodiments as the systems and methods for monitoring and maintaining the health of computing devices described herein may utilize any other a suitable formula or calculation method.

Upon detecting issues or anomalies that are deemed critical, health index module 130 may trigger an alert and initiate one or more automated responses, e.g., by using the script trigger module 140, to address potential problems before they impact overall system stability and performance.

System 100 further comprises dashboard interface 160 that is accessible by administrators, e.g., via administrator device 192. Dashboard interface 160 visually represents the health status of computing devices within system 100 and highlights areas that require immediate attention. Dashboard interface 160 may organize information in a logical troubleshooting flow to guide administrators through questions such as “Do I need to pay attention right now to the system?,” “What parts of the system are having problems?,” and “What can be done immediately to resolve issues?” Dashboard interface 160 provides detailed insights into specific components that may be contributing to a lowered health score and may include visual indicators, such as color-coded alerts, to represent the severity of health issues that have been identified as such. Through dashboard 160, administrators can initiate corrective actions or configure automated responses, such as software updates, configuration adjustments, or enforcement of security policies.

In embodiments, system 100 may be configured to integrate with cloud-based services to enable data aggregation and long-term analysis of health trends. Such integration enables system 100 to track historical health data across multiple devices, identify recurring patterns, and recommend preventive maintenance based on trends observed within the organization's fleet of computing devices. Such long-term insights support proactive maintenance strategies, and allow administrators to preemptively address potential issues before they escalate.

In embodiments, system 100 provides a holistic health representation of computing devices (e.g., 102) by offering a unified health index that encompasses various aspects of device performance, security, and compliance. This unified metric differs from conventional approaches, which rely on separate, fragmented data points. In contrast, the systems and method described herein can generate a single health index that is representative of the device's overall state, thereby simplifying the monitoring process for administrators and allowing them to assess device health at a glance.

A suitable health index may also incorporate comprehensive coverage of various device health factors, such as hardware performance, security settings, operating system status, and application versions. This inclusive approach ensures a more accurate, all-around view of devices' states, providing a level of insight not otherwise attainable through isolated metrics alone.

In embodiments, system 100 provides proactive maintenance capabilities by identifying indicators of potential issues. Health index module 130 and monitoring components may be configured to detect early indicators of failure, hardware degradation, security vulnerabilities, or performance drops to enable administrators to address these issues in advance. This preventive approach reduces the likelihood of device downtime and enhances overall reliability across the network.

Additionally, system 100 enables automation capabilities for preventive action. In embodiments, automated scripts or policies may be triggered when specific health factors fall below predefined thresholds to automatically correct misconfigurations, or initiate software updates to ensure compliance with organizational policies. Once a health index is generated, it may be used to identify and prioritize issues on each device, with real-time data sent to backend system 150 (e.g., a web interface) that displays device health and detected issues. Administrator 192 can then initiate further appropriate action, such as configuring automation or directly accessing the device for intervention. This functionality reduces or eliminates the need for manual intervention and significantly lowers administrative workload. By automating routine maintenance tasks and corrective actions, system 100 ensures continuous compliance with organizational policies and enhances operational efficiency by minimizing both downtime and resource usage.

In embodiments, the health index is calculated using a formula that subtracts various health factors from a perfect score of 100%. The formula takes the maximum value between zero and the result of subtracting the battery factor, storage factor, malware factor, and CPU factor from 100%. In this manner, the index ranges from 0 to 100 with 100 representing optimal device health with no issues detected, whereas a score of 0 indicates that at least one critical failure has been identified in the system.

Each health factor may represent a specific technical assessment: battery health considers charge cycles and capacity degradation, storage health uses exponential decay based on available space, malware assessment may employ weighted severity factors, and CPU health may incorporate uptime and temperature metrics. Health decrease events or factors may include battery health issues, malware detection, security configuration vulnerabilities, and CPU performance degradation. For example, malware monitoring may assess factors such as malware presence and severity, with specific weights applied for various malware types, e.g., adware (20%), trojans (60%), ransomware (60%), and advanced persistent threats (60%).

In addition to malware, the health index calculation may factor in a security checklist that evaluates compliance with various security protocols, e.g., each weighted by importance or criticality. For example, Secure Enclave status may contribute 15%, while FileVault status may contribute 10%. The checklist thus provides a weighted sum of security factors to ensure that a failure in one critical area directly impacts the overall health score.

In embodiments, malware assessment may use a weighted impact calculation where each malware type has a specific severity weight: adware and browser hijackers (20%), miners and installers (40%), and high-severity threats like trojans, ransomware, viruses, spyware, and rootkits (60%).

The malware impact for each type may be calculated as:

$$malware impact = severity weight \times ( 1 - {0.5}^{amount of malware instances} )$$

The cumulative malware factor may be the sum of all individual malware impacts, capped at 80% maximum impact to prevent complete system health degradation from malware alone.

CPU health is also considered within the health index formula. For example, CPU usage, temperature, and error rate are evaluated over a specified period (e.g., 8 hours) and weighted appropriately, such as 0.4 for CPU usage and 0.3 for both temperature and error rate. Other factors, such as device age or operating system version, may also contribute to the health index. An age factor may be calculated by comparing the current date to the device's manufacture date and expected end-of-life date, such as to provide a percentage health score based on the remaining operational lifespan.

A battery health factor may be included in the health index calculation via the following expression:

$$battery health factor = ( ( 1 - ( charge cycle count / design charge cycle limit ) + ( current maximum capacity / original design capacity ) + battery status ) / 3$$

where charge cycle limits may vary by device model, with some models having 1000 cycle limits and older models having 500 or 300 cycle limits; charge cycle count refers to the number of charge cycles a battery has undergone; current maximum capacity refers to the current maximum charge the battery can hold (measured in mAh or Wh); original design capacity refers to the battery's capacity when it was new (measured in mAh or Wh); and battery status may be classified as, e.g., good (100%), fair (75%), poor (50%), or replace (0%), each affecting the battery score. The impact of battery health on an overall health may be capped at, e.g., 50% such as to prevent battery issues from completely dominating the health assessment.

Similarly, CPU health, as a component of the health index, may consider CPU usage, temperature and error rate, which are evaluated over a predetermined period of time (e.g., 8 hours) and weighted with values such as 0.4 for CPU usage and 0.3 for both temperature and error rate. System 100 may monitor CPU temperature of CPU 104, with predefined thresholds such as normal operating range (30° C. to 55° C.), high temperature range (56° C. to 75° C.), and critical temperature range (above 76° C.). CPU health may also incorporate uptime impact calculated as:

$$UptimeImpact = IF ( UptimeDays >= 30 , 10 , IF ( UptimeDays >= 21 , \\ 8 , IF ( UptimeDays >= 14 , 5 , IF ( UptimeDays >= 7 , 2 , 0 ) ) ) ) .$$

For M Series CPUs, temperature pressure levels may be scored as: nominal (0), fair (5), serious (10), and critical (15). The total CPU factor may be calculated as UptimeImpact+CPU_Temperature_Impact. If the temperature of CPU 104 remains in the high or critical range for an extended period of time, system 100 may activate a CPU throttling process to reduce processing load to conserve energy and limit heat generation.

In embodiments, additional metrics such as crash rates may be incorporated, e.g., where the health impact of crashes is determined by the ratio of crashes to total launches within a specified period. When combined with other real-time data inputs, this metric can dynamically adjust the health index to ensure that the index accurately reflects the device's current operational state. System uptime may be tracked as an indicator of stability, reflecting time since the last system restart. Uptime contributes to the health index, with higher values possibly prompting recommendations for a reboot to maintain performance. For example, an uptime of 30 days may contribute 30% to the health index, 21 days may contribute 20%, and 14 days may contribute 10%.

In embodiments, storage health may be assessed using an exponential decay formula based on available storage space and SSD SMART health diagnostics. The storage health factor may be calculated as:

$$StorageHealthFactor = e {\hat{}}^{- AvailableStorageSpace / DecayRate} \times ( 1 - SSD\_SMART \_Health / 100 )$$

where the decay rate may be a constant (e.g., 25 GB) that defines how quickly the impact increases as storage decreases. The impact on health from storage issues may be capped at 25% and calculated as StorageHealthFactor×MaxImpact. The exponential approach ensures that critically low storage space has a disproportionately higher impact on overall health score.

It is understood that the numeral examples herein are illustrative and not limiting. These values may be adjusted based on specific system requirements, device configurations, or organizational policies, allowing flexibility in tailoring the health index calculation to different operational contexts.

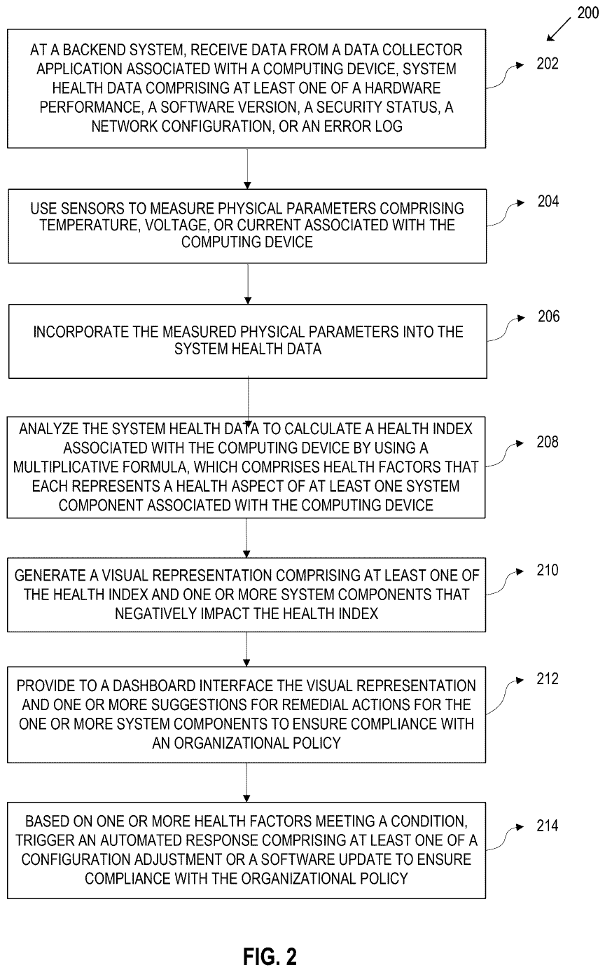

FIG. 2 is a flowchart illustrating an exemplary process for monitoring and maintaining the health of computing devices in a network according to various embodiments of the present disclosure. In embodiments, process 200 may start at step 202, when a backend system, such as backend system 150 illustrated in FIG. 1, obtains system health data from a data collector application, such as data collector application 120 in FIG. 1, which may be associated with one or more computing devices such as computing device 102 in FIG. 1. The system health data may comprise measured and/or computationally derived hardware performance metrics, such as CPU usage and memory utilization, software version information, security status, network configurations, or error logs, to perform comprehensive data collection across multiple system components.

At step 204, the backend system may use any number of sensors to measure physical parameters such as temperature, voltage, or current associated with the computing device.

At step 206, the backend system may incorporate the measured physical parameters into the system health data.

At step 208, the backend system may analyze the system health data to calculate a health index associated with the computing device, e.g., by using a multiplicative formula that comprises health factors. Each health factor may represent a health aspect of one or more system components. In embodiments, if any health factor is zero (indicating a critical issue), the entire health index may assume a zero value, emphasizing immediate attention to the critical problem. In embodiments, backend system may apply any machine learning technique known in the art to aid in data analysis and presentation.

At step 206, the backend system may generate a visual representation that comprises the health index and one or more system components that negatively impact the health index. This visual representation may use color-coded indicators, filters to view device health based on specific criteria, and a breakdown of the contribution of each health factor to the overall health index to enhance the usability of the health information for administrators.

At step 208, the backend system may provide the visual representation, including one or more suggestions for remedial actions for the one or more system components, to a dashboard interface, e.g., to ensure compliance with an organizational policy. The dashboard may also display additional metrics, such as an average health index across devices, the number of devices with critical issues, or any device requiring immediate attention.

At step 210, based on one or more health factors meeting a condition, the backend system may trigger an automated response, which may comprise a configuration adjustment, a software update, and the like, to ensure compliance with the organizational policy. The response may comprise generating an alert or notification for the administrator, e.g., if the health index falls below a predefined threshold, as well as initiating software updates, adjusting configurations, or enforcing policy compliance to prevent further deterioration of device health. In addition, the backend system may dynamically recalculate the health index in response to real-time updates in system health data, including changes in security compliance, hardware performance, or software status, prioritizing key health factors like security and hardware performance.

In embodiments, the backend system supports long-term trend analysis and performance monitoring by storing historical health data for each computing device. This allows the backend to track health trends over time, predict potential failures, and recommend preventive actions based on historical performance patterns. Customizable alerts and notifications based on specific health thresholds may also be provided, enabling different access levels for health data and automated responses based on user status. Furthermore, the backend system may schedule preventive maintenance tasks based on predefined health thresholds. These tasks may include software updates, diagnostic tests, and security compliance checks, as well as preventive measures such as security policy enforcement, or disk space management. The backend system may aggregate health data to provide organizational-level insights, such as device health summaries grouped by department, location, or device type, and comparative analyses across the network.

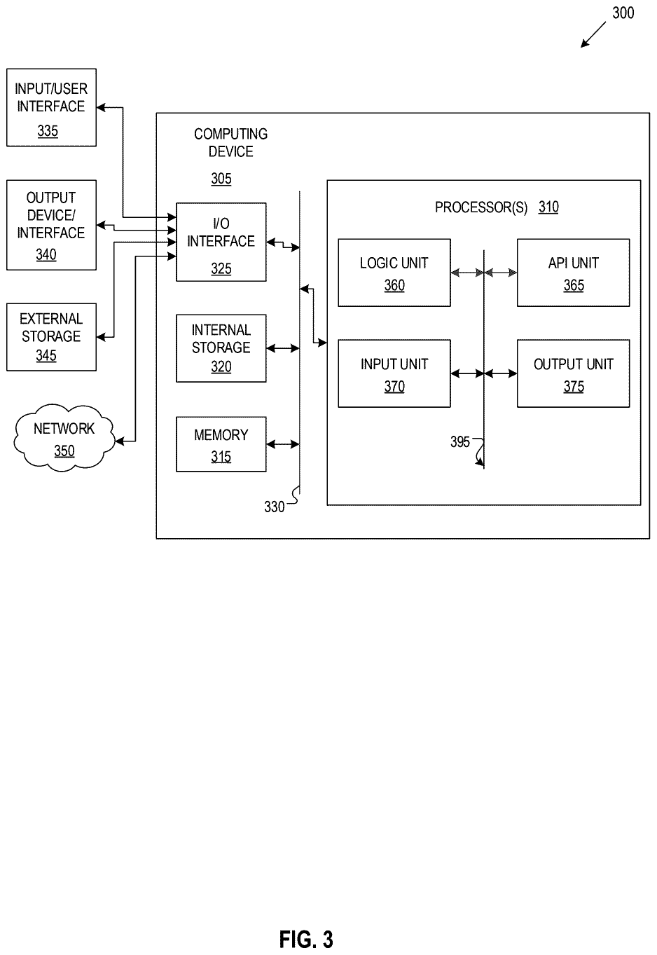

FIG. 3 illustrates an example computing environment with an example computer device suitable for use in some example implementations. Computer device 305 in computing environment 300 can include one or more processing units, cores, or processors 310, memory 315 (e.g., RAM, ROM, and/or the like), internal storage 320 (e.g., magnetic, optical, solid state storage, and/or organic), and/or I/O interface 325, any of which can be coupled on a communication mechanism or bus 330 for communicating information or embedded in the computer device 305. I/O interface 325 is also configured to receive images from cameras or provide images to projectors or displays, depending on the desired implementation.

Computer device 305 can be communicatively coupled to input/user interface 335 and output device/interface 340. Either one or both of input/user interface 335 and output device/interface 340 can be a wired or wireless interface and can be detachable. Input/user interface 335 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 340 may include a display, television, monitor, printer, speaker, braille, or the like. In some example implementations, input/user interface 335 and output device/interface 340 can be embedded with or physically coupled to the computer device 305. In other example implementations, other computer devices may function as or provide the functions of input/user interface 335 and output device/interface 340 for a computer device 305.

Examples of computer device 305 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 305 can be communicatively coupled (e.g., via I/O interface 325) to external storage 345 and network 350 for communicating with any number of networked components, devices, and systems, including one or more computer devices of the same or different configuration. Computer device 305 or any connected computer device can be functioning as, providing services of, or referred to as a server, client, thin server, general machine, special-purpose machine, or another label.

I/O interface 325 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 300. Network 350 can be any network or combination of networks (e.g., the Internet, local area network, wide area network, a telephonic network, a cellular network, satellite network, and the like).

Computer device 305 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 305 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 310 can execute under any operating system (OS) (not shown), in a native or virtual environment. One or more applications can be deployed that include logic unit 360, application programming interface (API) unit 365, input unit 370, output unit 375, and inter-unit communication mechanism 395 for the different units to communicate with each other, with the OS, and with other applications (not shown). The described units and elements can be varied in design, function, configuration, or implementation and are not limited to the descriptions provided. Processor(s) 310 can be in the form of hardware processors such as central processing units (CPUs) or in a combination of hardware and software units.

In some example implementations, when information or an execution instruction is received by API unit 365, it may be communicated to one or more other units (e.g., logic unit 360, input unit 370, output unit 375). In some instances, logic unit 360 may be configured to control the information flow among the units and direct the services provided by API unit 365, input unit 370, output unit 375, in some example implementations described above. For example, the flow of one or more processes or implementations may be controlled by logic unit 360 alone or in conjunction with API unit 365. The input unit 370 may be configured to obtain input for the calculations described in the example implementations, and the output unit 375 may be configured to provide output based on the calculations described in example implementations.

Processor(s) 310 can be configured to execute a method or computer instructions which can involve receiving system health data from a data collector application associated with a computing device, the system health data including at least one of a hardware performance metric, a software version, a security status, a network configuration, or an error log, as described, for example, with respect to FIG. 1.

Processor(s) 310 can be configured to execute a method or computer instructions which can involve analyzing the system health data to calculate a health index associated with the computing device by using, e.g., a multiplicative formula that comprises health factors that each represents a health aspect of at least one system component associated with the computing device, as described, for example, with respect to FIG. 2.

Processor(s) 310 can be configured to execute a method or computer instructions which can involve generating a visual representation including at least one of the health index and one or more system components that negatively impact the health index, as described, for example, with respect to FIG. 1 and FIG. 2.

Processor(s) 310 can be configured to execute a method or computer instructions which can involve providing to a dashboard interface the visual representation and one or more suggestions for remedial actions for the one or more system components to ensure compliance with an organizational policy, as described, for example, with respect to FIG. 2.

Processor(s) 310 can be configured to execute a method or computer instructions which can involve triggering, based on one or more health factors meeting a condition, an automated response including at least one of a configuration adjustment or a software update to ensure compliance with the organizational policy, as described, for example, with respect to FIG. 2.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for monitoring and maintaining the health of computing devices in a network, the method comprising:
at a backend system, receiving system health data from a data collector application associated with a computing device, the system health data comprising at least one of a hardware performance metric, a software version, a security status, a network configuration, or an error log;
using one or more sensors to measure physical parameters comprising at least one of temperature, voltage, or current associated with the computing device;
incorporating the measured physical parameters into the system health data;
analyzing the system health data to calculate a health index associated with the computing device by using a formula, which comprises health factors that each represents a health aspect of at least one system component associated with the computing device;
generating a visual representation comprising at least one of the health index and one or more system components that negatively impact the health index;
providing to a dashboard interface the visual representation and one or more suggestions for remedial actions for the one or more system components to ensure compliance with an organizational policy; and
based on one or more health factors meeting a condition, triggering an automated response comprising at least one of a configuration adjustment or a software update to ensure compliance with the organizational policy.

2. The method of claim 1, wherein the data collector application monitors and collects software version information, which comprises at least one of an installed application or its current version, hardware performance metric comprising at least one of a CPU usage, a memory utilization, a disk space, or a security compliance status.

3. The method of claim 1, wherein the data collector application reports the system health data based on information gathered within a time interval, and wherein the backend system aggregates the system health data from all computing devices in a network to present a holistic view of device health at an organizational level and recalculates the health index in response to a real-time change in a system status of the computing device.

4. The method of claim 3, wherein the backend system aggregates the system health data to provide organizational information comprising a device health summary based on at least one of a department, a location, or a device grouping, and provides a comparative analysis of device health across the network.

5. The method of claim 1, wherein the one or more sensors comprise at least one of a temperature sensor that measures a CPU temperature or a voltage sensor that measures a battery voltage.

6. The method of claim 1, wherein the dashboard interface visually represents the health index using color-coded indicators, provides filters to view device health based on a criterion, and shows a contribution of each of the one or more health factors to the health index.

7. The method of claim 1, wherein the automated response comprises at least one of initiating a software update or generating an alert or a notification for an administrator when the health index of the computing device falls below a predefined threshold.

8. The method of claim 1, wherein the backend system displays a metric that comprises at least one of an average health index, a number of devices associated with a critical issue, or a device requiring immediate attention.

9. The method of claim 1, wherein the backend system enables long-term trend analysis and performance monitoring by storing historical system health data for each computing device and tracking trends in the system health data over time to identify patterns, predict potential failures, and recommend preventive actions based on historical performance.

10. The method of claim 1, wherein the backend system allows customization of alerts and notifications based on specific thresholds for one or more health factors, and provides access control to enable different levels of access to health data and automated responses based on user status.

11. The method of claim 1, wherein the backend system automatically schedules preventive maintenance tasks comprising a software update, a diagnostic test, and a security compliance check based on predefined health thresholds, and automatically enforces preventive measures comprising at least one of a security policy compliance, disk space management, or software update scheduling based on one or more predetermined conditions.

12. The method of claim 1, wherein the backend system dynamically recalculates the health index in response to a real-time update in system health data, which comprises a change in security compliance, the hardware performance metric, or a software status, and prioritizes health factors that comprise the security compliance or the hardware performance metric.

13. The method of claim 1, wherein the dashboard interface displays a contribution of the one or more system components and provides a real-time monitoring result of system health to trigger a response when a critical issue has been detected.

14. The method of claim 1, wherein the backend system automatically, in response to detecting a deviation, enforces compliance with an organizational security or software policy to initiate a corrective action.

15. A non-transitory computer readable medium for storing instructions for executing a process, the instructions comprising:
receiving system health data at a backend system from a data collector application associated with a computing device, the system health data comprising at least one of a hardware performance, a software version, a security status, a network configuration, or an error log;
using one or more sensors to measure physical parameters comprising at least one of temperature, voltage, or current associated with the computing device;
incorporating the measured physical parameters into the system health data;
analyzing the system health data to calculate a health index associated with the computing device by using a formula, which comprises health factors that each represents a health aspect of at least one system component associated with the computing device;
generating a visual representation comprising at least one of the health index and one or more system components that negatively impact the health index;
providing to a dashboard interface the visual representation and one or more suggestions for remedial actions for the one or more system components to ensure compliance with an organizational policy; and
based on one or more health factors meeting a condition, triggering an automated response comprising at least one of a configuration adjustment or a software update to ensure compliance with the organizational policy.

16. The non-transitory computer readable medium of claim 15, wherein the data collector application reports the system health data based on information gathered within a time interval, and wherein the backend system aggregates the system health data from all computing devices in a network to present a holistic view of device health at an organizational level and recalculates the health index in response to a real-time change in a system status of the computing device.

17. The method of claim 1, wherein the backend system enables long-term trend analysis and performance monitoring by storing historical health data for each computing device and tracking trends in the system health data over time to identify patterns, predict potential failures, and recommend preventive actions based on historical performance.

18. The method of claim 1, wherein the backend system dynamically recalculates the health index in response to a real-time update in system health data, which comprises a change in security compliance, a hardware performance, or a software status, and prioritizes health factors that comprise the security compliance or the hardware performance.

19. The method of claim 1, wherein the dashboard interface displays a contribution of the one or more system components, the contribution comprising hardware performance, software status, or security compliance, and provides a real-time monitoring result of system health to trigger a response when a critical issue has been detected.

20. The method of claim 1, wherein the backend system automatically, in response to detecting a deviation, enforces compliance with an organizational security or software policy to initiate a corrective action.
